(19) United States
(12) Patent Application Publication
(10) Pub. No.: US 2007/0234396 A1
(43) Pub. Date: Oct. 4, 2007

(54) Method and apparatus for transmitting and receiving electronic service guide of interaction channel in a digital video broadcasting system

(75) Inventors: Hye-Young Lee, Seoul (KR); Jae-Yeon Song, Seoul (KR); Kook-Heui Lee, Yongin-Si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/640,743

(22) Filed: Dec. 18, 2006

(30) Foreign Application Priority Data
Dec. 16, 2005 (KR) 124811-2005

(51) Int. Cl. H04N 7/16

(52) U.S. Cl. 725/136

(57) ABSTRACT

A method and apparatus for transmitting and receiving an Electronic Service Guide (ESG) of an interaction channel in a Digital Video Broadcasting (DVB) system are provided. In order to transmit the ESG, ESG data about acquisition information is collected and it is determined whether a service associated with the ESG data is transmitted on an interaction channel. If the service is transmitted on the interaction channel, service access information needed to the interaction channel is set in a first field added for setting interaction channel information in an acquisition fragment of the ESG data. If the service is not transmitted on the interaction channel, service access information needed to receive a unidirectional broadcast channel is set in a second field configured to transmit information for accessing a service stream of the unidirectional broadcast channel in an old-version acquisition fragment. The ESG data including the acquisition fragment with the service access information set is transmitted to a receiving terminal.

### PRIORITY

This application claims priority under 35 U.S.C. §119 to an application entitled “Method And Apparatus For Transmitting And Receiving Electronic Service Guide Of Interaction Channel In A Digital Video Broadcasting System” filed in the Korean Intellectual Property Office on Dec. 16, 2005 and assigned Serial No. 2005-124811, the contents of which are herein incorporated by reference.

### BACKGROUND OF THE INVENTION

1. Field of the Invention

The present invention relates generally to a digital broadcasting system, and in particular, to an acquisition fragment structure for the Electronic Service Guide (ESG) of an interaction channel and a method and apparatus for transmitting and receiving the ESG in a Digital Video Broadcasting (DVB) system.

2. Description of the Related Art

Transmission technology for digital broadcasting finds its use in a variety of broadcasting systems including Digital Audio Broadcasting (DAB), DVB, and Digital Multimedia Broadcasting (DMB). Already a dominant digital broadcasting technology in Europe, DVB is a transmission standard for supporting mobile and portable digital multimedia services as well as existing digital broadcasting.

The DVB system multiplexes Moving Picture Experts Group-2 (MPEG2) Transport Stream (TS)-based broadcasting data with Internet Protocol (IP)-based data streams and simultaneously transmits them. Also, the DVB system multiplexes a plurality of services in one IP stream for transmission. When receiving the IP stream, a terminal demultiplexes the IP stream into individual services, demodulates the TSs of an intended service, and visually outputs the demodulated TSs to a user. The user may desire to obtain knowledge of the services available in the DVB system and the contents of the individual services.

In order to provide information about the individual services, the DVB system uses an ESG. ESG data contains information about time and contents of the services, and information required to receive and purchase the contents. For efficient transmission of the ESG data, the DVB system configures an ESG data model and determines transmission data based on the ESG data model.

FIG. 1 illustrates the ESG data model. Referring to FIG. 1, each block represents an ESG data fragment. Specifically, an ESG data model 100 includes a service fragment 102, a schedule event fragment 104, a content fragment 106, an acquisition fragment 108, a service bundle fragment 110, a purchase fragment 112, and a purchase channel fragment 114.

The service fragment 102 provides a comprehensive description of a service. The schedule event fragment 104 specifies the broadcast time information of a content item of a service. The acquisition fragment 108 specifies the purchase information of a service, required to receive actual data. The service bundle fragment 110 specifies a bundle of services. A bundle is understood to be a group of items offered to a user in the form of services. The purchase fragment 112 provides the purchase information of the service bundle. The purchase channel fragment 114 describes a purchase channel through which the user can interact with a purchase system to purchase the service bundle.

In the ESG data model, each fragment may reference another fragment, and the references between the fragments are depicted as arrows. A reference is defined as provisioning of information associated with one fragment by information carried in another fragment. For example, if one service is composed of a plurality of content items, the service fragment 102 simply describes the service comprehensively by providing the name and language of the service. For a description of a content item delivered by the service, the service fragment 102 is referred to by the content fragment 106 corresponding to the content item. Information needed for the terminal to receive the service, for example, session information of a transmission protocol is acquired by demodulating the acquisition fragment 108 that is referred to by the service fragment 102.

The ESG data is transmitted to the terminal in an IP stream other than an actual data stream at a different time. Therefore, a service provider can transmit all information that the user needs to know before receiving an actual service by the ESG data model 100. By receiving the ESG stream, the terminal acquires information required to receive a service provided by the service provider. When the user selects a specific service, the terminal accesses a data stream of the service and thus receives data. The information for accessing the service data stream is carried by the acquisition fragment 108 illustrated in FIG. 1.

Table 1 below describes the syntax of the acquisition fragment 108 in the ESG data of the DVB system.

TABLE 1

```
<complexType name=”AcquisitionType”>
            <sequence>
                <element name=”ComponentDescription”
                    type=”esg:ComponentDescriptionType”
                    maxOccurs=”unbounded”/>
                <element name=”ZappingSupport”
                type=”esg:ZappingSupportType”
                    minOccurs=”0”/>
                <element name=”KeyStream” type=”esg:
                KeyStreamBaseType” minOccurs=”0”
                    maxOccurs=”unbounded”/>
            </sequence>
            <attribute name=”contentMimeType”
            type=”mpeg7:mimeType” use=”required”/>
            <attribute name=”acquisitionID” type=”anyURI”
            use=”required”/>
    </complexType>
    <complexType name=”ComponentDescriptionType”>
            <Sequence>
                <element name=”ComponentCharacteristic”
                    type=”esg:ComponentCharacteristicType”
                    minOccurs=”0”
                    maxOccurs=”unbounded”/>
                <element name=”SessionDescription”
                    type=”esg:SessionDescriptionBaseType”/>
            </sequence>
        </complexType>
```

Referring to Table 1 above-herein, the acquisition fragment 108 is declared by “AcquisitionType”. The acquisition fragment's 108 attributes are “contentMimeType” and “acquisitionID”. “[A]cquisitionID” specifies a unique identifier of the acquisition fragment 108. Thus, a plurality of acquisition fragments can be declared because each acquisition fragment has a different “acquisitioned” as its attribute. “[C]ontentMimeType” specifies the type of the service referring to “acquisitionType”, through which the terminal can determine whether the service can be reproduced. The elements of “acquisitionType” are “componentDescription”, “ZappingSupport” and “KeyStream”.

“[C]omponentDescription” describes a component of the service referring to the acquisition fragment 108. The elements “componentCharacteristic” and “SessionDescription” are under “componentDescription”. “[C]omponentCharacteristic” specifies the description of component characteristics, and it includes characteristic fields for an audio component, a video component, and a file download component. “SessionDescription” contains a Session Description Protocol (SDP) that describes the session of a stream carrying the components. The SDP file is transmitted together with the ESG stream, or the SDP file is transmitted in a different stream and the ESG stream carries the session information of the different stream. In the former case, “SessionDescription” delivers SDP file contents, while in the latter case, “SessionDescription” carries the session information of the stream with the SDP file.

“ZappingSupport” is a field for transmitting zapping data to be displayed for a delay time when the user zaps channels. The zapping data is directly delivered in “ZappingSupport” or in a separate stream. In the latter case, “ZappingSupport” provides information about the stream carrying the zapping data.

“KeyStream” signals are available key streams for decryption, if the service referred to by the acquisition fragment 108 is encrypted.

The terminal acquires information required to access service streams by the acquisition fragment 108 described in Table 1 herein.

If a service is provided on a unidirectional broadcasting channel, the acquisition fragment 108 has only the fields that provide information about a protocol by which to access the unidirectional broadcast channel. Today, the DVB system render interaction channels over a mobile communication network as well as unidirectional broadcast channels over a broadcasting network to be available in receiving broadcast contents and broadcast services. Accordingly, in the case where a broadcast service is provided on an interaction channel, interaction channel-related information should be provided in the ESG data stream so that the user can receive the broadcast service on the interaction channel.

### SUMMARY OF THE INVENTION

An object of the present invention is to substantially solve at least the above problems and/or disadvantages and to provide at least the advantages below. Accordingly, the present invention defines an acquisition fragment structure in an ESG, through which to provide information about an interaction channel for effectively supporting a service on the interaction channel in a DVB system, and provides a method and apparatus for transmitting and receiving the ESG in the DVB system.

According to an aspect of the present invention, there is provided a method for transmitting an ESG in a digital broadcasting system using an interaction channel, where ESG data about acquisition information to be transmitted in an ESG stream is collected and it is determined whether a service associated with the ESG data is transmitted on an interaction channel by identification information in the ESG data. If the service is transmitted on the interaction channel, a first field for setting interaction channel information is added in an acquisition fragment of the ESG data and service access information needed to receive the service on the interaction channel is set in the first field. If the service is not transmitted on the interaction channel, service access information needed to receive the service on a unidirectional broadcast channel is set in a second field configured to transmit information for accessing a service stream of the unidirectional broadcast channel in an old-version acquisition fragment. The ESG data including the acquisition fragment with the service access information set is transmitted to a receiving terminal.

According to another aspect of the present invention, there is provided a method for transmitting an ESG in a digital broadcasting system using an interaction channel, where ESG data about acquisition information to be transmitted in an ESG stream is collected and it is determined whether a service associated with the ESG data is transmitted on an interaction channel by identification information in the ESG data. If the service is transmitted on the interaction channel, a new-version acquisition fragment is defined and service access information needed to receive a service on the interaction channel is set in the new-version acquisition fragment. If the service is transmitted on the interaction channel, service access information needed to receive a service on a unidirectional broadcast channel is set in an old-version acquisition fragment. The ESG data including the acquisition fragment with the service access information set is transmitted to a receiving terminal.

According to a further aspect of the present invention, there is provided a method for receiving an ESG in a digital broadcasting system using an interaction channel, where ESG data including a plurality of fragments is received and an acquisition fragment from among the plurality of fragments is demodulated. It is determined from the demodulated acquisition fragment whether a current service is transmitted on a unidirectional broadcast channel or an interaction channel. If the service is transmitted on the unidirectional broadcast channel, unidirectional broadcast channel information included in the acquisition fragment is set as service reception information. If the service is transmitted on the interaction channel, interaction channel information included in the acquisition fragment is set as service reception information. The service is received on one of the unidirectional broadcast channel and the interaction channel according to the service reception information.

According to still another aspect of the present invention, there is provided an apparatus for transmitting an ESG in a digital broadcasting system using an interaction channel, which includes a fragment encoder that collects ESG data about acquisition information to be transmitted in an ESG stream, encodes the ESG data in fragments according to the characteristics of the data, and organizes the fragments to an ESG container. An encapsulator encapsulates service data in the ESG container and a multiplexer multiplexes the encapsulated data with Television (TV) stream data. A modulator modulates the multiplexed transmission stream and transmits the modulated data through a transmit antenna. Here, the fragment encoder determines whether a service associated with the ESG data is transmitted on an interaction channel by identification information in the ESG data, adds a first field for setting interaction channel information in an acquisition fragment of the ESG data and sets service access information needed to receive the service on the interaction channel in the first field, if the service is transmitted on the interaction channel, sets service access information needed to receive the service on a unidirectional broadcast channel in a second field configured to transmit information for accessing a service stream of the unidirectional broadcast channel in an old-version acquisition fragment, if the service is not transmitted on the interaction channel.

According to yet another aspect of the present invention, there is provided an apparatus for transmitting an Electronic Service Guide (ESG) in a digital broadcasting system using an interaction channel, which includes a fragment encoder that collects ESG data about acquisition information to be transmitted in an ESG stream, encodes the ESG data in fragments according to the characteristics of the data, and organizes the fragments to an ESG container. An encapsulator encapsulates service data and the ESG container. A multiplexer multiplexes the encapsulated data with TV stream data. A modulator modulates the multiplexed transmission stream and transmits the modulated data through a transmit antenna. The fragment encoder determines whether a service associated with the ESG data is transmitted on an interaction channel by identification information in the ESG data, defines a new-version acquisition fragment and setting service access information needed to receive a service on the interaction channel, if the service is transmitted on the interaction channel, and sets service access information needed to receive a service on a unidirectional broadcast channel in an old-version acquisition fragment, if the service is not transmitted on the interaction channel.

According to a yet further aspect of the present invention, there is provided an apparatus for receiving an ESG in a digital broadcasting system using an interaction channel, which includes a demodulator that demodulates a service signal received through an antenna. A demultiplexer demultiplexes the demodulated data into an encapsulated IP packet and a transmission stream. A decapsulator demodulates the encapsulated IP packet to an IP stream. An ESG processor demodulates ESG fragments by analyzing an ESG stream in the IP stream and provides ESG data including the demodulated ESG fragments to a user interface. An interaction channel receiver sets interaction channel information received from the user interface as service reception information, receives a service on the interaction channel, and provides the service to the user interface. Here, the user interface determines from an acquisition fragment whether the service is transmitted on a unidirectional broadcast channel or an interaction channel, provides unidirectional broadcast channel information included in the acquisition fragment as the service reception information to the interaction channel receiver, if the service is transmitted on the unidirectional broadcast channel, and provides the interaction channel information included in the acquisition fragment as the service reception information to the interaction channel receiver, if the service is transmitted on the interaction channel.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating an ESG data model;

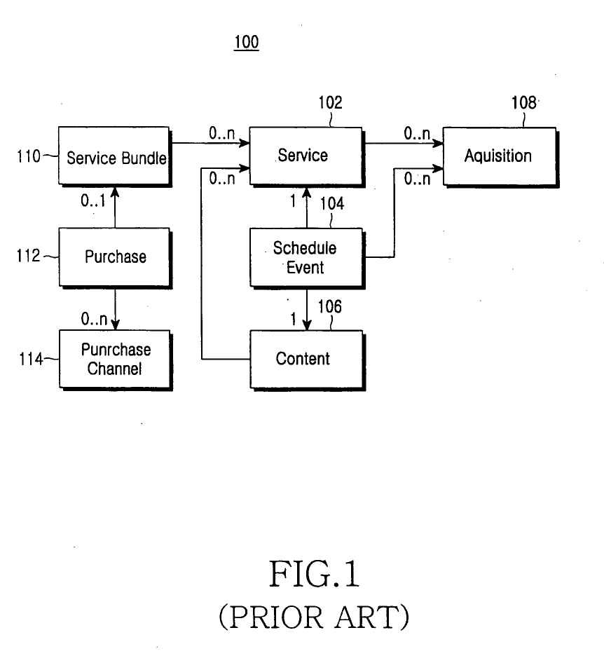

FIG. 2 is a flowchart illustrating the basic concept of transmission according to the present invention;

FIG. 3 is a flowchart illustrating the basic concept of reception according to the present invention;

FIG. 4 is a block diagram illustrating a transmitter according to the present invention; and

FIG. 5 is a block diagram illustrating a receiver according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

In accordance with the present invention, in the case where a user receives a broadcasting service on an interaction channel, a new field is added to an acquisition fragment in an ESG in order to preliminarily transmit information about the interaction channel, which is needed to receive the broadcasting service.

In accordance with the present invention, in the case where a user receives a broadcasting service on an interaction channel, a new-version acquisition fragment is defined, which includes a field indicating a reference to an old-version acquisition fragment in order to preliminarily transmit information about the interaction channel, needed to receive the broadcasting service.

Table 2 below describes the syntax of a new-version acquisition fragment with a new element for carrying information about an interaction channel according to the present invention.

```
TABLE 2
<complexType name=”AcquisitionType”>
        <sequence>
            <element name=”ComponentDescription”
                type=”esg:ComponentDescriptionType”
                maxOccurs=”unbounded”/>
            <element name=”ZappingSupport”
            type=”esg:ZappingSupportType”
                minOccurs=”0”/>
            <element name=”KeyStream”
            type=”esg: KeyStreamBaseType” minOccurs=”0”
                maxOccurs=”unbounded”/>
        </sequence>
        <attribute name=”contentMimeType” type=”mpeg7:mimeType”
        use=”required”/>
        <attribute name=”acquisitionID” type=”anyURI”
        use=”required”/>
    </complexType>
    <complexType name=”ComponentDescriptionType”>
        <Sequence>
            <element name=”ComponentCharacteristic”
                type=”esg:ComponentCharacteristicType”
                minOccurs=”0”
                maxOccurs=”unbounded”/>
            <choice>
            <element name=”SessionDescription”
                type=”esg:SessionDescriptionBaseType”
                minOccurs=”0”/>
            <element name=”InteractiveRef”
            type=”esg:InteractiveRefType”
                    minOccurs=”0” maxOccurs=”unbounded”/>
            <choice/>
          </sequence>
    </complexType>
```

Referring to Table 2, the new-version acquisition fragment is identical to the old acquisition fragment described in Table 1, except for an additional “interactiveRef” element under “ComponentDescryptionType”.

“[I]nteractiveRef” provides information about the interaction channel and thus, it resides at the same position as “SessionDescription” that carries information necessary to access a service stream to receive a unidirectional broadcast channel in the old acquisition fragment. The interaction or unidirectional service transmission scheme is identified by ESG data received from a service provided and the stream access information is also included in the ESG data. Only one of “InteractiveRef” and “SessionDescription” is meaningful for one service component depending on the service transmission scheme. Hence, <choice> in the XML language is used to allow one of “InteractiveRef” and “SessionDescription” to be selectively created. The present invention is not limited to the name of the added field and thus, any name is available provided it has a type that allows for transmission of interaction channel information.

“InteractiveRefType” describes the type of “InteractiveRef”. “InteractiveReffype” is a new complex-type XML scheme defined to deliver the interaction channel information in the DVB system. The present invention is not limited to the type name. The syntax of “InteractiveRefType” will be described herein.

Table 3 below describes the syntax of a new-version acquisition fragment with a new field for making a reference to an old-version acquisition fragment and another new field for delivering information about an interaction channel according to the present invention.

TABLE 3

```
<complexType name=”AcquisitionType2”>
        <sequence>
            <element name=”AcquisitionRef”
            type=”esg:ESGIDrefType”
            minOccurs=”0”/>
            <element name=”ComponentDescription”
                type=”esg:NewComponentDescriptionType”
                maxOccurs=”unbounded”/>
        <sequence>
</complexType>
    <complexType name=” NewComponentDescriptionType”>
        <sequence>
            <element name=”ComponentCharacteristic”
                type=”esg: ComponentCharacteristicType”
                minOccurs=”0”
                maxOccurs=”unbounded”/>
            <element name=”InteractiveRef”
            type=”esg:InteractiveRefType”
                maxOccurs=”unbounded”/>
        </sequence>
    </complexType>
```

In Table 3 above, “AcquisitionType2” declares the new acquisition fragment. “AcquisitionType2” has elements “AcquisitionRef” and “ComponentDescription”.

“AcquisitionRef” indicates an old acquisition fragment to which the new acquisition fragment makes a reference. The use of “AcquisitionRef” obviates the need for repeating the information of the old acquisition fragment and allows the new acquisition fragment to share the information with the old acquisition fragment.

“SessionDescription” in the old acquisition fragment is not required when the new acquisition fragment is transmitted to provide the interaction channel information. Thus, “SessionDescription” is not set to any value so that a new-version terminal can neglect “SessionDescription” in the old acquisition fragment.

“ComponentDescription” describes a service component that refers to the new acquisition fragment and includes the interaction channel information that enables reception of the service component on the interaction channel. The type of “ComponentDescription” is “NewComponentDescriptionType”. “NewComponentDescriptionType” includes “ComponentCharacteristic” that describes the service component and “InteractiveReF” that carries the interaction channel information.

“ComponentCharacteristic” has been described in Table 1. “InteractiveRefType” describes the type of “InteractiveRef”. “InteractiveRefType” is a new complex-type XML schema defined to deliver the interaction channel information in the DVB system. The present invention is not limited to the type name.

Table 4 below describes the syntax of “InteractiveRefType” added to deliver the interaction channel information.

```
TABLE 4
<complexType name=”InteractiveRefType”>
    <complexContent>
        <extension base=”esg:SessionDescriptionBaseType”>
            <sequence>
                    <element name=”TransmissionScheme”
                        type=”esg:TransmissionSchemeType”
                        minOccurs=”0”/>
                    <element name=”AssociatedDeliveryProcedure”
                    type=”anyURI”
            minOccurs=”0”/>
                </sequence>
        </extension>
    </complexContent>
</complexType>
```

“InteractiveRefType” is declared to provide the interaction channel information. It includes fields needed in order to receive a service on the interaction channel. The extension base of “InteractiveReffype” is “SessionDescriptionBaseType” under which there are the elements “TransmissionScheme” and “AssociatedDeliveryProcedure”.

“SessionDescriptionBaseType” is a type declared in the DVB system. It includes a field for directly transmitting an SDP field in the ESG stream to transmit session information, and a field for, when the SDP file is transmitted in a stream other than the ESG stream, delivering session information of the stream.

In accordance with the present invention, “TransmissionScheme” and “AssociatedDeliveryProcedure” are added under “SessionDescriptionBaseType” to configure “InteractiveRefType”.

“AssociatedDeliveryProcedure” carries the Uniform Resource Identifier (URI) of a configuration file describing a transmission scheme. Since the transmission scheme-associated configuration file is not transmitted in the ESG stream, “AssociatedDeliveryProcedure” indicates the position of the transmission scheme-associated configuration file.

“TransmissionScheme” is a type declared to transmit the interaction channel information.

Two embodiments are provided herein to configure “TransmissionScheme”. Table 5 illustrates an embodiment of the syntax of the type of “TransmissionScheme”, “TransmissionSchemeType” to transmit the interaction channel information in the acquisition fragment of the second embodiment of the present invention.

TABLE 5

```
<complexType name=”TransmissionSchemeType”>
    <sequence>
        <element name=”Scheme” type=”enum”
        minOccurs=”0”/>
        <element name=”AccessServerIPaddress” type=”string”
        minOccurs=”0”
            maxOccurs=”unbounded”/>
        <element name=”AccessServerURL” type=”string”
        minOccurs=”0”
            maxOccurs=”unbounded”/>
        <element name=”AccessServerPhoneNumber”
        type=”string” minOccurs=”0”
            maxOccurs=”unbounded”/>
    </sequence>
</complexType>
```

“TransmissionScheme” has elements “Scheme”, “AccessServerIPaddress”, “AccessServerURL”, and “AccessServerPhoneNumber”.

“Scheme” indicates the protocol that the interaction channel uses. It may declare all available protocols for the interactive service. “AccessServerIPaddress” specifies the IP address of a server that provides the interactive service. “AccessServerURL” specifies the URL of the server. “AccessServerPhoneNumber” indicates the phone number of the server.

Table 6 below illustrates another embodiment of the syntax of the type of “TransmissionScheme”, “TransmissionSchemeType” to transmit the interaction channel information in the acquisition fragment of the second embodiment of the present invention.

```
TABLE 6
<complexType name=”TransmissionSchemeType”>
    <sequence>
        <element name=”Scheme” type=”enum” minOccurs=”0”/>
        <element name=”AccessServer” type=”string” minOccurs=”0”
            maxOccurs=”unbounded”/>
    </sequence>
</complexType>
```

“TransmissionScheme” has elements “Scheme” and “AccessServer”. “Scheme” indicates the protocol that the interaction channel uses. It may declare all available protocols for the interactive service. “AccessServer” provides information about a server that provides the interactive service. Its value can be any of the IP address, URL, and phone number of the server.

Transmission, reception, and the structures of a transmitter and a receiver are the same in the first and second embodiments of the present invention described above. Therefore, the common transmission, reception, and structures of a transmitter and a receiver will be described below.

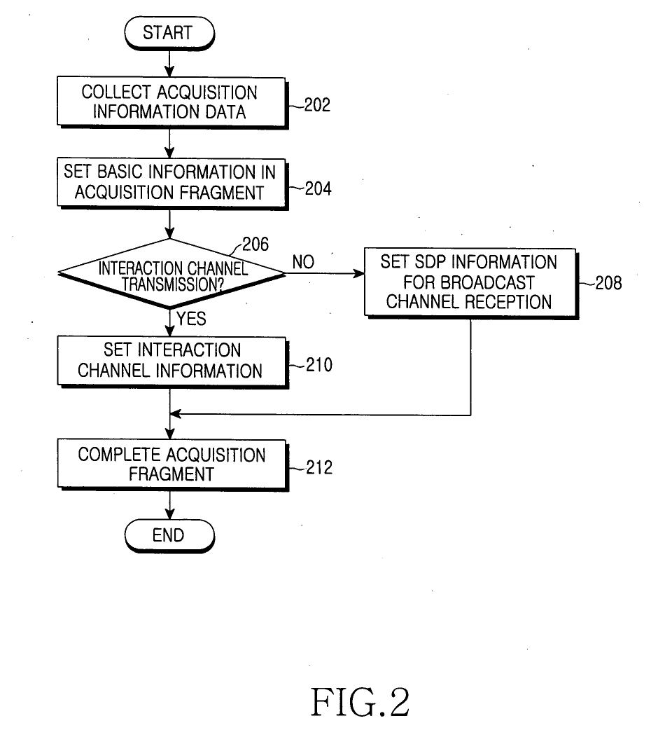

FIG. 2 is a flowchart illustrating the basic concept of transmission according to the present invention. The transmission operation takes place in a transmitter, particularly a part for generating ESG data.

Referring to FIG. 2, the transmitter collects ESG data about acquisition information to be transmitted in an ESG stream in step 202 and sets basic information in an acquisition fragment using the acquisition information data in step 204. In step 206, the transmitter determines whether a service to which the acquisition fragment refers is interaction channel transmission. If the service is not interaction channel transmission, this means that the service is unidirectional broadcast channel transmission. Thus, the transmitter accesses a service stream of the unidirectional broadcast channel and sets SDP information needed for service acquisition in the acquisition fragment in step 208. Alternatively, if the service is interaction channel transmission, the transmitter sets information needed to receive a service stream on the interaction channel in the old-version acquisition fragment illustrated in Table 2 or the new-version acquisition fragment illustrated in Table 3 in step 210. In step 212, the acquisition fragment is completed using the basic information set in step 204.

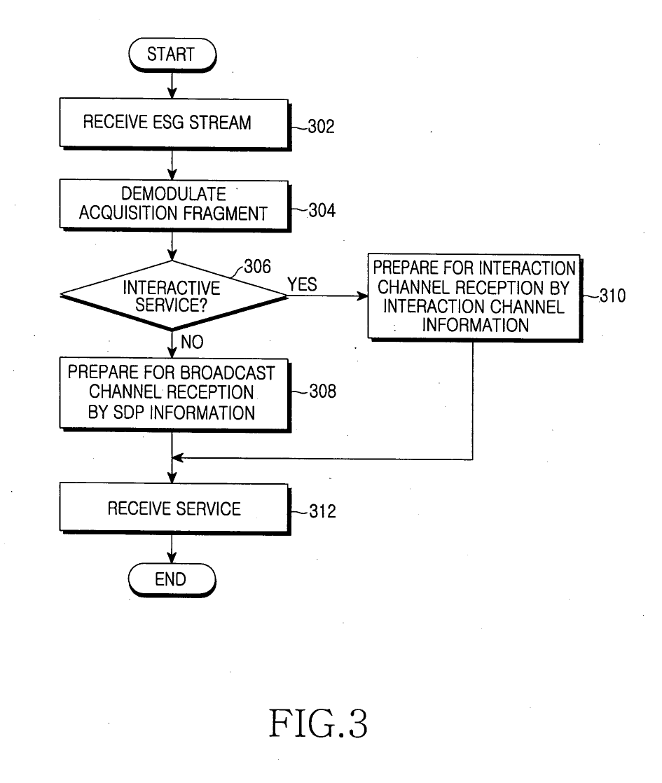

FIG. 3 is a flowchart illustrating the basic concept of reception according to the present invention.

Referring to FIG. 3, a receiving terminal receives an ESG stream in step 302 and demodulates an acquisition fragment from the ESG stream in step 304. In step 306, the terminal determines whether a service of which the acquisition information is provided by the acquisition fragment is provided on one of a unidirectional broadcast channel and an interaction channel. In the case of a unidirectional broadcast channel, the terminal sets SDP information included in the acquisition fragment as information for service reception in step 308. In the case of an interaction channel, the terminal sets interactive transmission information included in the acquisition fragment as the information for service reception in step 310. In step 312, the terminal prepares for service reception based on the service reception information and receives the service at the time when the service is transmitted.

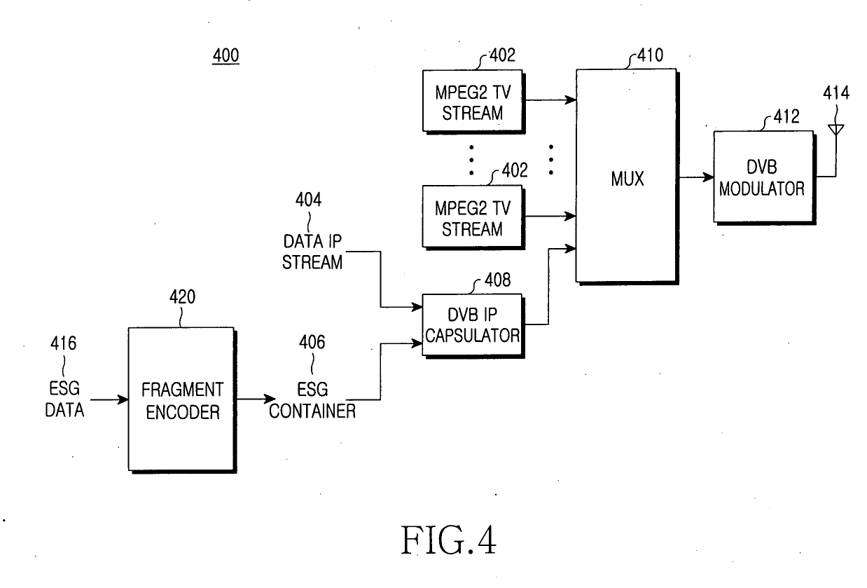

FIG. 4 is a block diagram of a transmitter according to the present invention. Referring to FIG. 4, a DVB transmitter 400 receives a plurality of Moving Picture Expert Group-2 (MPEG2) TV streams 402 and an IP stream. The IP stream is a data IP stream 404 including IP-based service data. ESG data 416 created to transmit an ESG of the MPEG2 streams 402 and the data IP stream 404 are also transmitted in an IP stream. A fragment encoder 420 encodes the ESG data 416 in each fragment according to the characteristics of the data. The coded ESG fragments are organized to an ESG container 406. The ESG container 406 is provided together with the data IP stream 404 in the form of an IP stream to a DVB IP encapsulator 408.

The DVB IP encapsulator 408 encapsulates the IP streams 404 and 406 in an MPEG2 TS. A Multiplexer (MUX) 406 multiplexes the MPEG2 TS with the MPEG2 TV streams 402. A DVB modulator 412 modulates the multiplexed TS to Orthogonal Frequency Division Multiplexing (OFDM) symbols and transmits them through a transmit antenna 414.

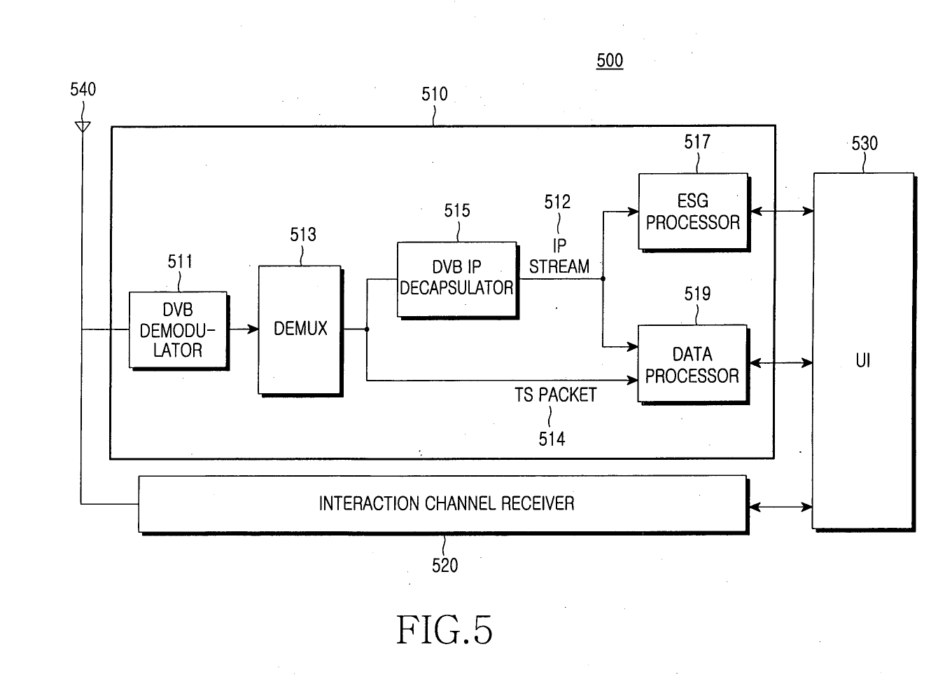

FIG. 5 is a block diagram of a receiver according to the present invention.

Referring to FIG. 5, a DVB receiver 500 receives a signal through a receiver antenna 540. A DVB demodulator 511 of a broadcast channel receiver 510 OFDM-demodulates the received signal. A Demultiplexer (DEMUX) 513 demultiplexes the demodulated data into an encapsulated IP packet and an MPEG2 TS packet stream 514. The TS packet stream 514 is processed in a data processor 519 to enable a user to view a corresponding service. The encapsulated IP packet is demodulated to an IP stream 512 in an IP decapsulator 515. The demodulated IP stream 512 is broke up into an ESG stream and a data stream. As with the TS packet stream 514, the data stream is processed in the data processor 519, and the ESG stream is provided to an ESG processor 517. The ESG processor 517 demodulates the ESG stream to ESG fragments and provides ESG data including the demodulated ESG fragments to a User Interface (UI) 530.

The UI 530 acquires reception information about all services from the ESG data, and provides information about a service on an interaction channel to an interaction channel receiver 520. The interaction channel receiver 520 sets information for receiving the service on the interaction channel and receives the service on the interaction channel. The UI 530 displays service data received from the interaction channel receiver 520.

In accordance with the present invention as described above, a transmitter transmits information about an interaction channel in an acquisition fragment of an ESG and a receiving terminal sets service reception information from the interface channel information. Therefore, a service can be effectively received on the interaction channel.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmitting an Electronic Service Guide (ESG) in a digital broadcasting system using an interaction channel, comprising the steps of:
collecting ESG data about acquisition information for transmitting in an ESG stream;
determining whether a service associated with the ESG data is transmitted on an interaction channel by identification information in the ESG data;
adding a first field for setting interaction channel information in an acquisition fragment of the ESG data and setting service access information needed to receive the service on the interaction channel in the first field, if the service is transmitted on the interaction channel;
setting service access information needed to receive the service on a unidirectional broadcast channel in a second field configured to transmit information for accessing a service stream of the unidirectional broadcast channel in an old-version acquisition fragment, if the service is not transmitted on the interaction channel; and
transmitting the ESG data including the acquisition fragment with the service access information set to a receiving terminal.

2. The method of claim 1, wherein the acquisition fragment is configured such that one of the first and second fields is selected.

3. A method of transmitting an Electronic Service Guide (ESG) in a digital broadcasting system using an interaction channel, comprising the steps of:
collecting ESG data about acquisition information for transmitting in an ESG stream;
determining whether a service associated with the ESG data is transmitted on an interaction channel by identification information in the ESG data;
defining a new-version acquisition fragment and setting service access information needed to receive a service on the interaction channel in the new-version acquisition fragment, if the service is transmitted on the interaction channel, and setting service access information needed to receive a service on a unidirectional broadcast channel in an old-version acquisition fragment, if the service is not transmitted on the interaction channel; and
transmitting the ESG data including the acquisition fragment with the service access information set to a receiving terminal.

4. The method of claim 3, wherein the new-version acquisition fragment includes a field for indicating a reference relationship between the new-version acquisition fragment and the old-version acquisition fragment.

5. The method of claim 4, wherein when the new-version acquisition fragment is defined, a field for providing the service access information of the unidirectional broadcast channel is not set to any value in the old-version acquisition fragment that is referred to by the new-version acquisition fragment.

6. A method of receiving an Electronic Service Guide (ESG) in a digital broadcasting system using an interaction channel, comprising the steps of:
receiving ESG data including a plurality of fragments;
demodulating an acquisition fragment from among the plurality of fragments;
determining from the demodulated acquisition fragment whether a current service is transmitted on one of a unidirectional broadcast channel and an interaction channel;
setting unidirectional broadcast channel information included in the acquisition fragment as service reception information, if the service is transmitted on the unidirectional broadcast channel, and setting interaction channel information included in the acquisition fragment as service reception information, if the service is transmitted on the interaction channel; and
receiving the service on one of the unidirectional broadcast channel and the interaction channel according to the service reception information.

7. The method of claim 6, wherein the acquisition fragment is configured by adding a field for providing service access information to access a service stream on the interaction channel to an old-version acquisition fragment.

8. The method of claim 6, wherein the acquisition fragment is a new-version acquisition fragment including a field for providing service access information to access a service stream on the interaction channel.

9. An apparatus for transmitting an Electronic Service Guide (ESG) in a digital broadcasting system using an interaction channel, comprising:
a fragment encoder for collecting ESG data about acquisition information to be transmitted in an ESG stream, encoding the ESG data in fragments according to the characteristics of the data, and organizing the fragments to an ESG container;
an encapsulator for encapsulating service data and the ESG container;
a multiplexer for multiplexing the encapsulated data with Television (TV) stream data;
a modulator for modulating the multiplexed transmission stream and transmitting the modulated data through a transmit antenna,
wherein the fragment encoder determines whether a service associated with the ESG data is transmitted on an interaction channel by identification information in the ESG data, adds a first field for setting interaction channel information in an acquisition fragment of the ESG data and sets service access information needed to receive the service on the interaction channel in the first field, if the service is transmitted on the interaction channel, sets service access information needed to receive the service on a unidirectional broadcast channel in a second field configured to transmit information for accessing a service stream of the unidirectional broadcast channel in an old-version acquisition fragment, if the service is not transmitted on the interaction channel.

10. The apparatus of claim 9, wherein the acquisition fragment is configured such that one of the first and second fields is selected.

11. An apparatus for transmitting an Electronic Service Guide (ESG) in a digital broadcasting system using an interaction channel, comprising:
a fragment encoder for collecting ESG data about acquisition information to be transmitted in an ESG stream, encoding fragments the ESG data in fragments according to the characteristics of the data, and organizing the fragments to an ESG container;
an encapsulator for encapsulating service data and the ESG container;
a multiplexer for multiplexing the encapsulated data with Television (TV) stream data;
a modulator for modulating the multiplexed transmission stream and transmitting the modulated data through a transmit antenna,
wherein the fragment encoder determines whether a service associated with the ESG data is transmitted on an interaction channel by identification information in the ESG data, defines a new-version acquisition fragment and setting service access information needed to receive a service on the interaction channel, if the service is transmitted on the interaction channel, and sets service access information needed to receive a service on a unidirectional broadcast channel in an old-version acquisition fragment, if the service is not transmitted on the interaction channel.

12. The apparatus of claim 11, wherein the new-version acquisition fragment includes a field indicating a reference relationship between the new-version acquisition fragment and the old-version acquisition fragment.

13. The apparatus of claim 12, wherein when the new-version acquisition fragment is defined, a field for providing the service access information of the unidirectional broadcast channel is not set to any value in the old-version acquisition fragment that is referred to by the new-version acquisition fragment.

14. An apparatus for receiving an Electronic Service Guide (ESG) in a digital broadcasting system using an interaction channel, comprising:
a demodulator for demodulating a service signal received through an antenna;
a demultiplexer for demultiplexing the demodulated data into an encapsulated Internet Protocol (IP) packet and a transmission stream;
a decapsulator for demodulating the encapsulated IP packet to an IP stream;
an ESG processor for demodulating ESG fragments by analyzing an ESG stream in the IP stream and providing ESG data including the demodulated ESG fragments to a user interface; and
an interaction channel receiver for setting interaction channel information received from the user interface as service reception information, receiving a service on the interaction channel, and providing the service to the user interface,
wherein the user interface determines from an acquisition fragment whether the service is transmitted on one of a unidirectional broadcast channel and an interaction channel, provides unidirectional broadcast channel information included in the acquisition fragment as the service reception information to the interaction channel receiver, if the service is transmitted on the unidirectional broadcast channel, and provides the interaction channel information included in the acquisition fragment as the service reception information to the interaction channel receiver, if the service is transmitted on the interaction channel.

15. The apparatus of claim 14, wherein the acquisition fragment is configured by adding a field for providing service access information to access a service stream on the interaction channel to an old-version acquisition fragment.

16. The apparatus of claim 14, wherein the acquisition fragment is a new-version acquisition fragment including a field for providing service access information to access a service stream on the interaction channel.
